(19) United States
(12) Patent Application Publication
(10) Pub. No.: US 2008/0248254 A1
(43) Pub. Date: Oct. 9, 2008

(54) METHOD OF MANUFACTURING OPTICAL INFORMATION RECORDING MEDIUM AND THE OPTICAL INFORMATION RECORDING MEDIUM

(75) Inventors: Yasuhito Hagiwara, Gunma (JP); Motomitsu Hagiwara, Gunma (JP); Takeshi Otsu, Gunma (JP); Akimasa Miyata, Gunma (JP); Kuniyuki Aihara, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/035,981

(22) Filed: Feb. 22, 2008

(30) Foreign Application Priority Data
Mar. 6, 2007 (JP) 2007-55099

(51) Int. Cl. B32B 3/30; B05D 5/06

(52) U.S. Cl. 428/167; 427/162

(57) ABSTRACT

An optical information recording medium of which the commercial value is not reduced is provided, in which a light reflection layer, an optical recording layer, a first light transmission layer, and a second light transmission layer are provided in this order on one main surface of a disk-shaped substrate, and a method of manufacturing the optical information recording medium is provided. A light reflection layer, an optical recording layer, a protection layer, a first light transmission layer, and a second light transmission layer may be provided in this order on the one main surface of the disk-shaped substrate. The substrate has a first groove and a second groove approximately concentrically formed nearer an inner circumference of the substrate than an area in which the optical recording layer is to be provided. The first light transmission layer is provided such that an edge thereof is situated near an edge of an outer circumferential side of the first groove. The second light transmission layer is provided such that an edge thereof is situated near an edge of an outer circumferential side of the second groove. Therefore, each of the first and second light transmission layers does not meander at an inner circumferential edge thereof in a circumferential direction, leading to excellent quality in appearance.

### BACKGROUND OF THE INVENTION

1. Field of the Invention

The present invention relates to a disk-shaped, optical information recording medium and a method of manufacturing the medium, and more specifically, the invention relates to an optical information recording medium having a light reflection layer, an optical recording layer, and a light transmission layer in this order on one main surface of a disk-shaped substrate, and relates to a method of manufacturing the medium.

2. Description of the Related Art

Usually, a disk-shaped optical information recording medium such as write-once type CD (so-called CD-R) has a structure where a recording layer and a reflection layer are formed on one surface of a light-transmissive substrate having pregrooves provided thereon. The optical information recording medium is configured such that laser light typically having a wavelength near 780 nm is irradiated from a side of the other surface of the substrate, so that data are recorded and/or reproduced into/from the recording layer.

Moreover, a disk-shaped, optical information recording medium called write-once type digital-versatile disk (so-called DVD-R) is proposed. The disk has a structure where a recording layer and a reflection layer are similarly formed on one surface of a light-transmissive substrate having pregrooves provided thereon with a pitch half the pitch of the CD-R or less. The disk is configured such that laser light typically having a wavelength near 630 nm to 680 nm is irradiated from a side of the other surface of the substrate, so that data are recorded and/or reproduced into/from the recording layer.

Recently, digital terrestrial hi-vision TV has rapidly spread. Therefore, a disk-shaped optical information recording medium is actively being developed, in which high-density recording can be achieved with blue-violet laser light having a shorter wavelength compared with laser light for the DVD-R.

To achieve the high-density recording, for example, it is investigated that spot size is reduced by a method of increasing numerical aperture (NA) of an objective lens, or a wavelength of a laser to be used is reduced, thereby improving recording density of an optical disk. Moreover, a disk-shaped optical information recording medium corresponding to such a method is proposed. In the optical information recording medium, a translucent information recording area is formed to be in a thickness of about 0.1 mm from one main surface of the medium. In addition, it is proposed that data are recorded and/or reproduced into/from the optical information recording medium with NA of about 0.85 and a laser wavelength of about 400 nm. Specifically, an optical information recording medium called write-once type Blu-ray disk (so-called BD-R) or the like is proposed. The medium has a structure where a light reflection layer, an optical recording layer, and a light transmission layer are formed in this order on a substrate having a spiral groove formed thereon. The medium is configured such that blue-violet laser light typically having a wavelength near 400 nm to 500 nm is irradiated from a side of a surface having the light transmission layer thereon, so that data are recorded and/or reproduced into/from the recording layer.

Regarding such an optical information recording medium, the following proposal is made in JP-A-2005-71571, as shown in FIGS. 3A to 3C. In this proposal, when a plurality of coating films such as a recording layer 103 including organic dye, and a cover layer 0.1 mm in thickness including transparent resin are formed in a stacked manner in a thickness direction on one main surface 101a of a substrate 101, the coating films are sequentially formed by coating on the one main surface 101a of the disk-shaped substrate 101 while sequentially using caps 104, 114 and 124 covering a center hole 102 of the disk-shaped substrate 101.

Moreover, the following proposal is made in JP-A-4-247341, as shown in FIG. 4. In this proposal, grooves 205 are concentrically provided in an inner circumferential side of one main surface 204 of a disk-shaped substrate 201, and thereby edges at inner circumferential sides of coating films 202 and 209 are formed in an approximately round shape respectively.

In the optical information recording medium of the related art described in JP-A-2005-71571, a first cap 104, which has an outer diameter larger than the inner diameter of the center hole 102 of the substrate 101, is used at a side of the one surface 101a of the disk-shaped substrate 101. In addition, while the first cap is disposed such that the periphery of the cap is opposed to a portion near an inner circumferential edge of the one surface 101a of the substrate, for example, a first coating material is discharged onto the cap 104 through a nozzle 108, and the disk-shaped substrate 101 and the cap 104 are rotated with a predetermined rotation profile. Thus, a lower coating film 109 is formed by coating at the one surface 101a side of the substrate 101.

In the film formation, since a coating liquid 105 enters into a gap between the surface of the substrate 101 and the periphery of the cap 104 due to a capillary action, when the cap 104 is separated from the surface 101a of the substrate 101, irregularity in a thickness direction tends to occur on the surface near an inner circumferential edge of a coating film 109.

Next, similar to the above, a second cap 114, which has an outer diameter larger than the inner diameter of the lower coating film 109, is used on the lower coating film 109 formed at the one surface 101a side of the disk-shaped substrate 101. Then, while the second cap is disposed such that the periphery of the cap 114 is opposed to a portion near an inner circumferential edge of the lower coating film 109, for example, a second coating material 115 is discharged onto the second cap 114 through a nozzle 118, and the disk-shaped substrate 101 and the second cap 114 are rotated with a predetermined rotation profile. Thus, a second coating film 119 is formed by coating on the lower coating film 109.

However, in this film formation, irregularity in the thickness direction occurs near inner circumference of the lower coating film 109 as described before. Therefore, a gap between the coating film 109 and the periphery of the second cap 114 is varied in size, and therefore the coating liquid 115 entering into the gap due to the capillary action is varied in entering level in a direction to the center of a substrate. As a result, the upper coating film 119 meanders in a circumferential direction at its inner circumferential edge. Thus, there has been a problem that the optical information recording medium gives an impression from its appearance that the medium is a roughly-manufactured article, leading to reduction in commercial value. Moreover, the lower coating film 109 is partially protruded to the center and exposed at its inner circumferential edge from the inner circumferential edge of the upper coating film 119. Therefore, there has been a possibility that moisture or the like in the air enters into the lower coating film 109, resulting in reduction in quality such as reduction in light transmittance.

### SUMMARY OF THE INVENTION

An object of the invention is to provide an optical information recording medium that does not give an impression from its appearance that the medium is a roughly-manufactured article. Moreover, another object of the invention is to provide a method of manufacturing the optical information recording medium that does not give an impression from its appearance that the medium is a roughly-manufactured article.

A first embodiment of the invention includes an optical information recording medium, in which a light reflection layer, an optical recording layer, a first light transmission layer, and a second light transmission layer are provided in this order on one main surface of a disk-shaped substrate, and laser light can be irradiated from a side of the second light transmission layer so that information can be recorded into and/or reproduced from the medium. The substrate has a first groove formed nearer an inner circumference of the substrate than the optical recording layer on the one main surface of the substrate, and a second groove formed approximately concentrically with the first groove and nearer to the inner circumference than the first groove. The first light transmission layer is provided such that an edge of an inner circumferential side thereof is situated near an edge of an outer circumferential side of the first groove. The second light transmission layer is provided such that an edge of an inner circumferential side thereof is situated near an edge of an outer circumferential side of the second groove. Thus, the object is achieved.

According to the first embodiment, a portion in the inner circumferential side of the second light transmission layer covers the edge of the inner circumferential side of the first light transmission layer, and is formed along a portion near an edge of an outer circumferential side of the second groove. Therefore, the optical information recording medium can be prevented from giving an impression from its appearance that the medium is a roughly-manufactured article.

Moreover, according to the first embodiment, the portion in the inner circumferential side of the second light transmission layer securely covers the edge of the inner circumferential side of the first light transmission layer. Therefore, the optical information recording medium may not have a possibility of reduction in quality such as reduction in light transmittance due to entering of moisture in the air into the first light transmission layer.

A second embodiment of the invention includes a method of manufacturing an optical information recording medium, in which first and second light transmission layers are formed on one main surface of a disk-shaped substrate on which a light reflection layer and an optical recording layer are formed in this order, the transmission layers formed by coating a resin material by spin coating so as to cover the recording layer while using approximately disk-shaped caps for closing a center hole of the substrate respectively.

The method includes preparing the disk-shaped substrate on which a first and second groove are approximately concentrically formed at an inner circumferential side on the one main surface, and forming the light reflection layer on the one main surface of the substrate. The method further includes forming the optical recording layer on the light reflection layer formed on the substrate, and disposing an approximately disk-shaped first cap on the one main surface of the substrate such that a periphery of the first cap is opposed to a portion near an edge of an outer circumferential side of the first groove, and coating a transparent resin material by spin coating to form the first light transmission layer. Furthermore, the method includes disposing an approximately disk-shaped second cap having a diameter smaller than that of the first cap on the one main surface of the substrate such that a periphery of the second cap is opposed to a portion near an edge of an outer circumferential side of the second groove, and coating a transparent resin material by spin coating to form the second light transmission layer. Thus, the object is achieved.

According to the second embodiment, when the second light transmission layer is formed, the edge of the outer circumferential side of the relevant groove on the substrate can be opposed to the portion near the outer circumferential edge of the second cap with a predetermined space. This may suppress a phenomenon that the upper coating film of the second light transmission layer, which may be particularly exposed in the multi-layered coating films, meanders in a circumferential direction at an edge of an inner circumferential side of the upper coating film due to variation in occurrence of a capillary action. Thus, the optical information recording medium can be prevented from giving an impression from its appearance that the medium is a roughly-manufactured article. Consequently, a method of manufacturing an optical information recording medium of which the commercial value is not reduced can be provided.

The above objects and other objects, configurations and features, and operations and effects will be more clarified by the following description and accompanying drawings.

### BRIEF DESCRIPTION OF THE DRAWINGS

FIG. 1 shows a partially enlarged section view showing an internal structure of a first embodiment of an optical information recording medium of the invention;

FIGS. 2A to 2J show partially enlarged section views for illustrating a first embodiment of a method of manufacturing the optical information recording medium of the invention;

FIGS. 3A to 3C show partially enlarged section views showing an example of an optical information recording medium of the related art; and

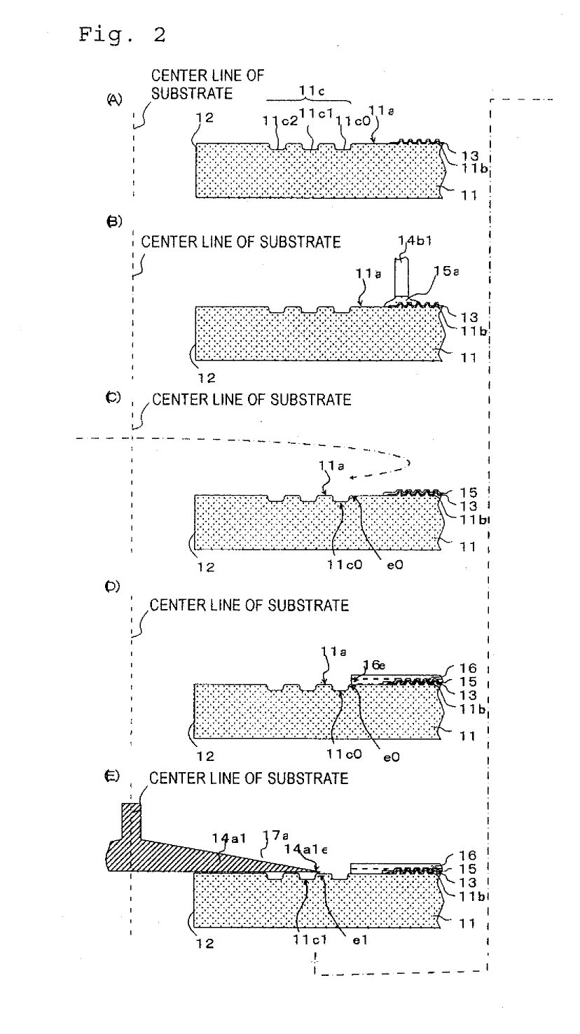

FIG. 4 shows a partially enlarged section view showing another example of an optical information recording medium of the related art.

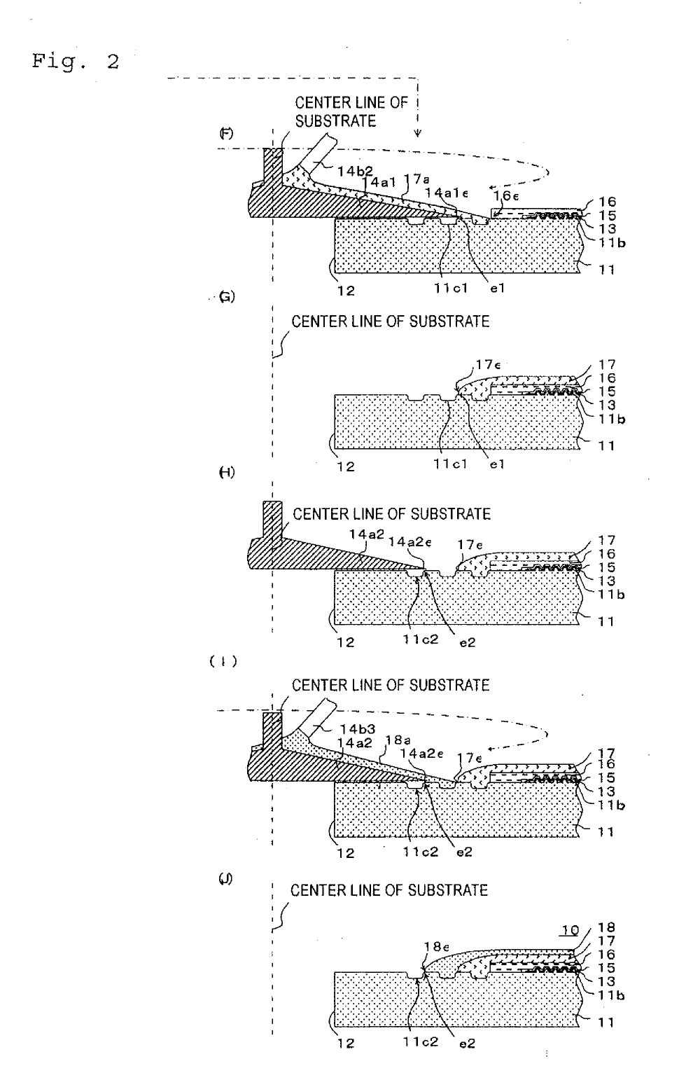

### DESCRIPTION OF THE PREFERRED EMBODIMENT

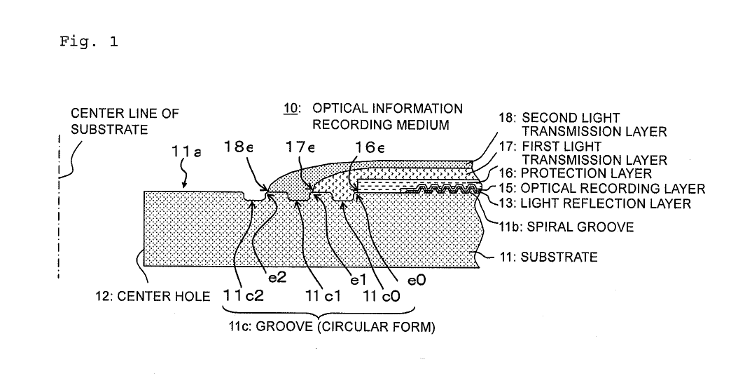

Hereinafter, a first embodiment of an optical information recording medium of the invention is described with reference to FIG. 1. FIG. 1 shows a partially enlarged section view showing a relevant part of an internal structure of the optical information recording medium 10 of the first embodiment. The figure shows only a relevant part on the right of the center of the disk-shaped substrate 11, and a part on the left of the center is omitted to be shown since it is approximately symmetric with the part on the right with respect to a center line of the substrate.

As shown in FIG. 1, the optical information recording medium 10 of the embodiment has a light reflection layer 13, an optical recording layer 15, and a first light transmission layer 17 and a second light transmission layer 18, wherein each transmission layer may include resin coating film, in this order on one main surface 11a of a disk-shaped substrate 11.

Specifically, the optical information recording medium 10 has the disk-shaped substrate 11, and the light reflection layer 13, the optical recording layer 15, a protection layer 16, the first light transmission layer 17, and the second light transmission layer 18 in this order on the one main surface 11a of the disk-shaped substrate 11. In the optical information recording medium 10, laser light is irradiated from a side of the second light transmission layer 18, so that information can be recorded into and/or reproduced from the medium 10.

On the one main surface 11a of the disk-shaped substrate 11, a spiral groove 11b, for use as a tracking guide when recording and/or reproducing by laser light irradiation, is formed typically in a range of about 46 mm to 117 mm in diameter. Furthermore, the light reflection layer 13 is formed so as to cover the spiral groove 11b. The optical recording layer 15 is formed on the light reflection layer 13. A first groove 11c1 is formed nearer an inner circumference of the substrate than the optical recording layer 15 on the one main surface 11a of the substrate 11, and a second groove 11c2 is formed approximately concentrically with the first groove and nearer to the inner circumference than the first groove 11c. The first light transmission layer 17 is provided such that an edge 17e of an inner circumferential side thereof is situated near an edge e1 of an outer circumferential side of the first groove 11c1.

The second light transmission layer 18 is provided such that an edge 18e of an inner circumferential side thereof is situated near an edge e2 of an outer circumferential side of the second groove 11c2.

Next, a preferred embodiment of the substrate 11 is described as follows. For the substrate 11, various materials used for substrate materials of a usual optical information recording medium can be optionally used. For example, polycarbonate, acrylic resin such as polymethylmethacrylate, vinyl chloride resin such as polyvinyl chloride and vinyl chloride copolymer, epoxy resin, amorphous polyolefin, polyester resin, metal such as aluminum, glass and the like can be used. These materials may be stacked and used together as needed. Among the materials, thermoplastic resin is preferable from the viewpoint of moldability, moisture resistance, size stability, and inexpensiveness, and polycarbonate is particularly preferable.

In the case of using these kinds of resin, the substrate 11 is preferably formed into a predetermined shape (in the case of an optical disk, disk shape) by a method such as injection molding, for example. Moreover, thickness of the substrate 11 is preferably in a range of about 0.9 to 1.6 mm. Furthermore, the resin is not limited to these types. For example, ultraviolet-curable resin may be used in a manner such that it is coated on a base, and then such a coating film is cured and then used.

On the substrate 11, the spiral groove 11b for use as a tracking guide for recoding and/or reproducing by laser light irradiation is preferably formed on the one main surface 11a on which the light reflection layer 13 is provided. The spiral groove 11b preferably has a depth of about 20 nm to 300 nm, and a pitch of typically about 500 nm or less. While not being shown, the spiral groove 11b is preferably formed as follows: a mold plate called a stamper, of which the one main surface is subjected to fine processing to have a spiral convex-filament about 20 nm to 300 nm in height, the convex-filament having a pattern opposite to that of the spiral groove 11b, is disposed within a molding die used for molding the substrate 1. Then the spiral groove 11b is formed concurrently with injection molding of the substrate 11. The spiral groove may also be formed using other methods known in the art.

Next, a preferred embodiment of the approximately concentric, first and second grooves 11c1 and 11c2 is described as follows. The approximately concentric first and second grooves 11c1 and 11c2 are formed nearer an inner circumference than an area in which the spiral groove 11b is to be formed on a surface of the substrate on which the optical recording layer 15 is to be provided, and preferably formed concurrently with molding of the substrate 11.

Depth of each of the first and second grooves 11c1 and 11c2 is preferably about 0.02 mm to 1.0 mm. Width of each of the first and second grooves 11c1 and 11c2 is preferably about 0.02 mm to 1.0 mm. A pitch of each of the first and second grooves 11c1 and 11c2 is preferably about 0.02 mm to 1.0 mm. Moreover, the first and second grooves 11c1 and 11c2 are preferably formed circularly about the center line of the substrate 11.

Each of the approximately concentric, first and second grooves 11c1 and 11c2 is large in depth compared with the spiral groove 11b for use as a tracking guide, and therefore hard to be formed by using the stamper. Therefore, while not being shown, the first and second grooves 11c1 and 11c2 are preferably formed concurrently with molding of the substrate 11 by providing a plurality of approximately concentric convex-filaments, each having a pattern opposite to the pattern of the approximately concentric grooves 11c, directly on an inner surface of a molding die, or on a surface of a center holder for fixing inner circumference of the stamper to the inside of the die.

Next, a preferred embodiment of the light reflection layer 13 is described as follows. The light reflection layer 13 reflects laser light for recording and/or reproducing data. In the invention, the light reflection layer 13 is preferably provided as needed between the substrate 11 and the optical recording layer 15 for increasing reflectivity to laser light, or for adding a function of improving a recording/reproducing characteristic. For the light reflection layer 13, a metal film such as a film of Au, Al, Ag, Cu or Pd, or an alloy film including such a metal, or an alloy film including such a metal added with a minor component is preferably used. The light reflection layer is preferably formed on the surface 11a of the substrate 11, on which the pregroove 11b is formed by deposition method, an ion plating method, a sputtering method or the like, for example. In particular, sputtering is preferably used from the viewpoint of manufacturability and cost.

Next, a preferred embodiment of the optical recording layer 15 is described as follows. The optical recording layer 15 is preferably a dye-type recording layer where organic dye is contained as a recording substance. In particular, preferably, the optical recording layer 15 is a dye-type recording layer in which a pit is formed by laser light irradiation for recording data. As such organic dye, phthalocyanine dye, cyanine dye, azo dye and the like, for example, are preferably given. Data such as music, images, and computer programs can be recorded into and/or reproduced from the optical recording layer 15. The optical recording layer 15 may be formed from a dye as follows: the dye is dissolved in an appropriate solvent with a binder and the like to prepare a coating liquid; then the coating liquid is coated on the substrate 11 directly or by way of a different layer by spin coating, screen printing or the like to form a coating film; and then the coating film is dried, thereby the optical recording layer 15 is formed. The different layer includes the light reflection layer 13.

Next, a preferred embodiment of the protection layer 16 is described as follows. The protection layer 16 is preferably formed by a method such as evaporation or sputtering using a material, for example, such as ZnS, SiO₂, SiN, AlN, ZnS—SiO₂, or SiC.

The protection layer 16 is preferably formed as needed between the optical recording layer 15 and the first light transmission layer 17 for the purpose of adjustment of recording characteristics or the like, improvement in adhesion, or protection of the recording layer, for example.

Next, a preferred embodiment of the first light transmission layer 17 is described as follows. The first light transmission layer 17 may be formed as follows: transparent ultraviolet-curable resin is dissolved in an appropriate solvent to prepare a coating liquid; then while using a first cap, the coating liquid is coated by spin coating so as to cover the optical recording layer 15 to form a coating film; and then the coating film is dried and irradiated with ultraviolet rays, so that the first light transmission layer 17 is formed.

Next, a preferred embodiment of the second light transmission layer 18 is described as follows. In a formation procedure of the second light transmission layer 18, first, transparent ultraviolet-curable resin may be dissolved in an appropriate solvent to prepare a coating liquid. Next, while using a second cap having a diameter smaller than that of the first cap, the coating liquid is coated by spin coating so as to cover the first light transmission layer 17 to form a coating film. Then, the coating film is dried and irradiated with ultraviolet rays, so that the second light transmission layer 18 is formed.

Since the optical information recording medium is configured such that laser light typically having a wavelength near 400 nm to 500 nm is irradiated to the recording layer so that data are recorded into and/or reproduced from the recording layer, preferably, total thickness of the first and second light transmission layers 17 and 18 is typically about 0.1 mm.

As described before, the protection layer 16 is preferably formed between the optical recording layer 15 and the first light transmission layer 17 for the purpose of adjustment of recording characteristics or the like, improvement in adhesion, or protection of the optical recording layer, for example. In this case, total thickness of the protection layer, optical recording layer 15, first light transmission layer 17, and second light transmission layer 18 is preferably about 0.1 mm.

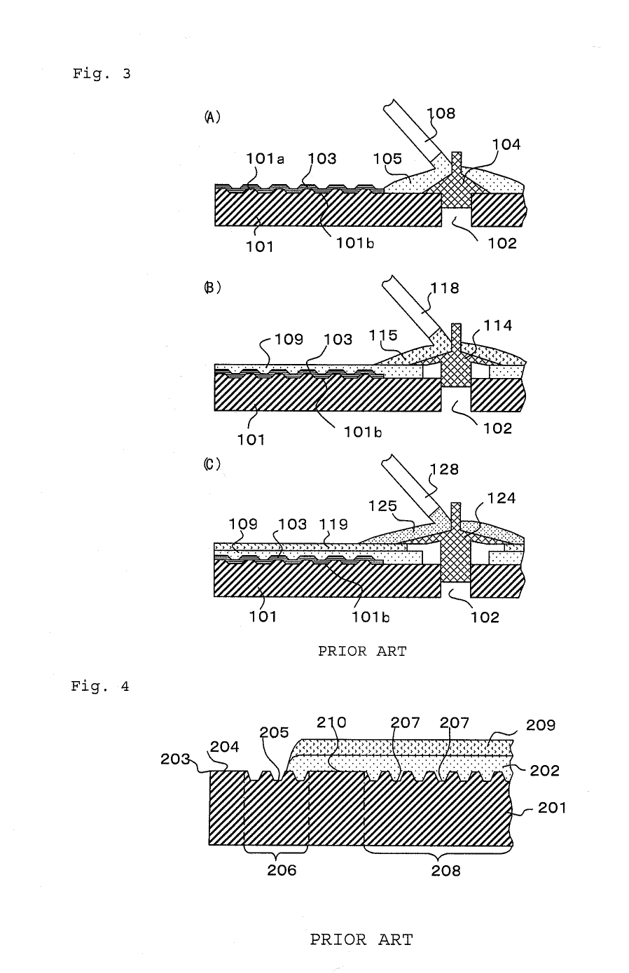

Next, a first embodiment of a method of manufacturing the optical information recording medium of the invention is described with reference to FIG. 2. FIG. 2 shows a partially enlarged section view for illustrating the method of manufacturing the optical information recording medium 10 of the first embodiment. The figure shows only a relevant part at the right of the center of the disk-shaped substrate 11, and a part at the left of the center is omitted to be shown since it is symmetric with the part at the right.

In the embodiment of a method of manufacturing the optical information recording medium 10 of the first embodiment, as shown in FIG. 1, the first and second light transmission layers are sequentially formed on the one main surface 11a, on which the light reflection layer 13 and the optical recording layer 15 are formed in this order, of the disk-shaped substrate 11 by coating a coating liquid including a transparent resin material by spin coating so as to cover the optical recording layer 15 while using approximately disk-shaped caps 14 for closing the center hole 12 of the substrate 11 respectively.

The method includes preparing the disk-shaped substrate 11 on which the first groove 11c1 and the second groove 11c2 are approximately concentrically formed at the inner circumferential side of the one main surface, and a step of forming the light reflection layer 13 on the main surface 11a of the substrate 11 as shown in FIG. 2A.

The method further includes forming the optical recording layer 15 on the light reflection layer 13 formed on the substrate 11 as shown in FIGS. 2B and 2C. The method further includes that a first cap 14a1 is disposed such that its periphery 14a1e is opposed to a portion near an edge e1 at an outer circumferential side of the first groove 11c1 as shown in FIG. 2E, and then a coating liquid 17a, which may include a transparent resin material, is coated by spin coating as shown in FIG. 2F to form the first light transmission layer 17 as shown in FIG. 2G. Furthermore, as shown in FIG. 2H, the method includes that a second cap 14a2 having a diameter smaller than that of the first cap 14a1 is disposed such that its periphery 14a2e is opposed to a portion near an edge e2 at an outer circumferential side of the second groove 11c2, being nearer to the inner circumference than the first groove 11c1. The method further includes a step of coating a coating liquid 18a, which may include a transparent resin material, by spin coating as shown in FIG. 2I to form the second light transmission layer 18 as shown in FIG. 2J.

### Example 1

First, a disk-shaped substrate 11 including polycarbonate resin was molded by injection molding (not shown), the substrate 11 having a thickness of 1.1 mm, an outer diameter of 120 mm, and an inner diameter of a center hole 12 of 15 mm. The substrate 11 has a spiral groove 11b with a track pitch of 0.32 μm on one main surface 11a. The substrate 11 further has approximately concentric, first and second grooves 11c1 and 11c2, each having a pitch of 0.4 mm, groove width of 0.2 mm, and groove depth of 0.1 mm, in an area where a radius from a center of the substrate is 22 mm to 44 mm. Furthermore, the substrate 11 has a spare groove 11c0 between the first groove 11c1 and the spiral groove 11b.

Next, as shown in FIG. 2A, a light reflection layer 13 including Ag alloy 100 nm in thickness was formed on the one main surface 11a side, in which the spiral groove 11b was formed, of the substrate 11, so as to cover the spiral groove 11b.

Next, an organic-dye coating liquid 15a was prepared, and the coating liquid 15a was dropped from a nozzle 14b1 onto the one main surface 11a of the substrate 11 as shown in FIG. 2B. Then, as shown in FIG. 2C, while the substrate was rotated with a predetermined rotation profile in spin coating, an optical recording layer 15 was formed by centrifugal force so as to cover the light reflection layer 13.

Next, as shown in FIG. 2D, a protection layer 16 including SiO₂ 50 nm in thickness was formed on the one main surface 11a of the substrate 11 by sputtering such that an edge at an inner circumferential side thereof was situated near an edge e0 at an outer circumferential side of the spare groove 11c0 so that the optical recording layer 15 was covered.

Next, as shown in FIG. 2E, a first cap 14a1 was disposed on the one main surface 11a of the substrate 11 such that its periphery 14a1e was opposed to a portion near the edge e1 at the outer circumferential side of the first groove 11c1. Then, a coating liquid 17a including an ultraviolet-curable, transparent resin material, which was supplied from a nozzle 14b2 on the surface of the first cap 14a1, was coated by spin coating as shown in FIG. 2F, so that a first light transmission layer 17 20 μm in thickness, covering the protection layer 16, was formed as shown in FIG. 2G.

Next, as shown in FIG. 2H, a second cap 14a2 having a diameter smaller than that of the first cap 14a1 was disposed such that its periphery 14a2e was opposed to a portion near an edge e2 at an outer circumferential side of the second groove 11c2, being nearer to the inner circumference than the first groove 11c1. Then, as shown in FIG. 2I, a coating liquid 18a including an ultraviolet-curable, transparent resin material was coated by spin coating, the resin material being supplied from a nozzle 14b3 on the surface of the second cap 14a2. Thus, a second light transmission layer 18, which had a thickness of 80 μm, and covered the first light transmission layer 17, was formed as shown in FIG. 2J.

According to the steps, the optical information recording medium 10 of example 1 was produced.

The edge 17e at the inner circumferential side of the first light transmission layer 17 on the first groove 11c1, and the edge 18e at the inner circumferential side of the second light transmission layer 18 on the second groove 11c2 on the one main surface 11a of the optical information recording medium 10 obtained as above were subjected to observation by optical microscopy at a magnification of 10 times. As a result, it was found that there was no meandering in a circumferential direction due to variation in occurrence of a capillary action. Moreover, the first light transmission layer 17 was completely covered with the second light transmission layer 18 even up to the edge 17e at the inner circumferential side thereof, and the edges were not exposed in any place. Consequently it was confirmed that there was no possibility of reduction in quality.

### Comparative Example 1

An optical information recording medium of a comparative example was produced in the same way as in the example 1 except that the second cap was used to form the first light transmission layer in place of the first cap. As in the example, an edge of a first light transmission layer and an edge of a second light transmission layer on the one main surface of the optical information recording medium were subjected to observation by optical microscopy at a magnification of 10 times. As a result, meandering in a circumferential direction due to variation in occurrence of a capillary action was observed at the edge of the first light transmission layer and the edge of the second light transmission layer. Moreover, the edge at the inner circumferential side of the first light transmission layer was exposed from the second light transmission layer. Consequently it was confirmed that there was a possibility of reduction in quality.

The protection layer 16 was provided in the example. However, the invention is not limited to this, and the protection layer 16 may be omitted.

Moreover, the spare groove 11c0 was provided between the first groove 11c1 and the spiral groove 11b on the one main surface 11a of the substrate 11. However, the invention is not limited to this, and the spare groove 11c0 may be omitted. Moreover, a spare groove may be provided similarly as the above between the first groove 11c1 and the second groove 11c2, or nearer to the inner circumference than the second groove 11c2.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium, comprising:
a light reflection layer, an optical recording layer, a first light transmission layer, and a second light transmission layer in this order on one main surface of a disk-shaped substrate,
wherein the optical information recording medium is configured such that information can be recorded into and/or reproduced from the optical information recording medium by laser light irradiated from a side of the second light transmission layer;
wherein the substrate has a first groove formed nearer an inner circumference of the substrate than the optical recording layer on the one main surface of the substrate, and a second groove formed approximately concentrically with the first groove and nearer to the inner circumference than the first groove;
wherein the first light transmission layer is provided such that an edge of an inner circumferential side thereof is situated near an edge of an outer circumferential side of the first groove; and
wherein the second light transmission layer is provided such that an edge of an inner circumferential side thereof is situated near an edge of an outer circumferential side of the second groove.

2. The optical information recording medium of claim 1, further comprising a protection layer between the optical recording layer and the first light transmission layer on the one main surface of the substrate.

3. The optical information recording medium of claim 1, wherein the area in which the optical recording layer is to be provided on the one main surface of the substrate has spiral grooves formed thereon.

4. A method of manufacturing an optical information recording medium, comprising:
preparing a disk-shaped substrate on which a first and second groove are approximately concentrically formed at an inner circumferential side on one main surface of the substrate,
forming a light reflection layer on the main surface of the substrate,
forming an optical recording layer on the light reflection layer formed on the substrate,
disposing an approximately disk-shaped first cap on the one main surface of the substrate such that a periphery of the first cap is opposed to a portion near an edge of an outer circumferential side of the first groove, and coating a transparent resin material by spin coating to form a first light transmission layer, and
disposing an approximately disk-shaped second cap having a diameter smaller than that of the first cap on the one main surface of the substrate such that a periphery of the second cap is opposed to a portion near an edge of an outer circumferential side of the second groove, and spin coating a transparent resin material to form a second light transmission layer.

5. The method of manufacturing an optical information recording medium of claim 4, further comprising forming a protection layer on the optical recording layer before forming the first light transmission layer.

6. The method of manufacturing an optical information recording medium of claim 4, wherein the optical recording layer is formed over an area of the main surface of the substrate having spiral grooves formed thereon.
